(19) United States
(12) Patent Application Publication
(10) Pub. No.: US 2003/0154085 A1
(43) Pub. Date: Aug. 14, 2003

(54) Interactive knowledge base system

(75) Inventor: Fredrick M. Kelley, Newbury Park, CA (US)

Correspondence Address: KOPPEL & JACOBS, Suite 107, 555 St. Charles Drive, Thousand Oaks, CA, 91360, US

(73) Assignee: ONEVOICE MEDICAL CORPORATION

(21) Appl. No.: 10/068,989

(22) Filed: Feb. 8, 2002

(51) Int. Cl. G10L 21/00

(52) U.S. Cl. 704/275

(57) ABSTRACT

Systems and methods for automatically recognizing and processing verbal data associated with medical treatment diagnosis and related billing, compliance and reporting procedures in the healthcare industry are provided. A method for completing and generating a claim form comprises providing an interactive voice interface for receiving and analyzing one or more verbal inputs to a computing system. The system interprets the one or more verbal inputs to fill one or more corresponding fields in an electronic form. The system continues to receive and analyze verbal inputs until the electronic form is completed. The system associates the content of the electronic form with one or more industry codes. The industry codes identify at least the nature of one or more services associated with the one or more verbal inputs. The system then arranges the codes in a predetermined manner to generate a claim for reimbursement that can be processed by a medical claims processing facility.

A portion of the disclosure of this patent document contains material that is subject to copyright protection. The owner has no objection to the facsimile reproduction by any one of the patent document or the patent disclosure as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or limit the scope of this invention to material associated only with such marks.

### BACKGROUND

1. Field of Invention

The present invention relates generally to data analysis and reporting and, more particularly, to an interactive knowledge base system for receiving and automatically processing verbal input for recognition and verifying the accuracy of the recognized input for reporting purposes, compliance requirements, medical procedure and diagnosis code generation, medical in-patient and out-patient insurance claims, and the generation of records and documents utilizing those inputs.

2. Related Art

The healthcare industry, due to issues typically associated with patients' privacy rights, quality of service, and fair billing practices, is heavily regulated. Healthcare providers, especially in the United States, need to comply and bill in accordance with specific governmental or industry standards in order to receive payment. The American Medical Association (AMA) has promulgated codes and guidelines that allow a healthcare professional or staff to report the nature of a medical diagnosis and/or the level of service provided with specificity.

Documentations such as Current Procedural Terminology (CPT) and International Classification of Disease (ICD) respectively define and codify most known medical procedures and diagnosis. A unique code is associated with a particular service, procedure or diagnosis. For example CPT code 76857 identifies a bladder ultrasound procedure. A selection of a proper procedure code can define a medical examination or procedure as more or less complex and therefore justify a higher or lower level of compensation. The level of service is represented by codes such as the following: 99201—New Patient; 99211—Established Patient; 99241—Consultation; 99271—Confirmatory Patient. Several codes together may record and report an entire visit or hospital stay.

An error, omission or inaccuracy in coding can lead to reduced reimbursement for services, and to the denial or substantial delay in payment of fees billed. Therefore, it is important for hospitals and healthcare providers or their staff to precisely code each medical procedure and diagnosis. Measures have been taken to automate the task of billing using required coding. Currently, a physician or other healthcare provider either dictates, types, charts or writes the nature of a medical procedure and corresponding diagnosis for each patient. Thereafter, someone transcribes each dictation or tries to interpret handwritten entries, as for example found in medical “orders” or “progress notes.” A person known as a “coder” analyzes the transcription to produce procedure and diagnosis codes for a claim form. The claim form contains the respective codes in formats necessary for submission of a medical claim for payment. Appendix A & B attached hereto and incorporated by reference herein are examples of outpatient and inpatient claim forms that are in current use.

There are many disadvantages associated with the current billing methods. For example, transcription costs can be expensive. Dictating, transcribing, coding and billing procedure are interdependent and prone to error as the same information has to be reprocessed and re-entered during each stage of the billing cycle. The manual processing of medical notes and verifying the accuracy of the bills and claims can be an arduous task and inundated with delays. For example, if a coder detects a transcription error in the physician's reports, the task of billing is delayed until the physician is contacted and the notes are corrected and forwarded back to the coder. Furthermore, since the physician's reports for similar medical diagnosis and procedures include highly repetitive language, dictating the same notes over and over again is highly inefficient and many times contains inadvertent omissions.

In recent years, billing and claim submission systems have been introduced that automate portions of the billing and claim reporting aspects of a hospital or medical practice. Unfortunately, however, while these systems simplify the tasks of coding and billing, they are not designed for direct incorporation into the practice of a healthcare provider at the point of care. In other words, using the current systems, information provided by a physician or other healthcare provider has to be analyzed by intermediate parties (e.g., transcribers, coders, billers, etc.) before systems that simplify the tasks of coding and billing are applied and a resultant claim form or electronic claim is generated. All records must also meet Medicare and other compliance requirements for both content and format for all dictated medical records.

For example, if a physician's reports cannot be read or if the physician has made an error in dictating a value or describing a procedure, a coder will have to consult the physician with respect to these matters or return the reports to the physician for further review and reconsideration. Modification of medical records, even if for the purpose of correcting inadvertent errors in transcription, can be considered to be improper. Therefore, it is extremely important that the dictated record is accurate and complete at the point of care so that the claim form can be generated and approved from a physician's dictation. It is further desirable that the dictated record is properly constituted to present an accurate medical record which fully supports appropriate billing and reimbursement for medical services provided. New methods and systems are needed that can address the above-mentioned needs and overcome the above-described shortcomings.

### SUMMARY

Systems and methods for automatically recognizing and processing verbally generated data associated with medical diagnosis, procedures performed, and related billing and reporting procedures in the healthcare industry are provided within the subject invention. In accordance with one or more embodiments of the invention, a method for completing and generating a medical claim form or electronic claim comprises providing an interactive voice interface for receiving and analyzing one or more verbal inputs to a computing system. The system interprets the one or more verbal inputs to fill one or more corresponding fields in a standardized medical claim format and is specially constituted to solicit required procedural, diagnosis, and medical record compliance information. That is, the system accepts a first input, generally verbal, for a corresponding first field if the first input complies with a set of requirements. Otherwise, the system provides a prompt for a second or alternative inputs to prompt the user to bring the input into billing and compliance standards in healthcare.

The system continues to receive and analyze inputs until both the compliance and billing requirements are completed. The system associates the electronic form with one or more procedural codes. The codes identify at least the nature of one or more services or medical procedures associated with the one or more inputs. The system then arranges the codes in a predetermined manner that can be processed by a claims processing facility. In some embodiments, the system associates the inputs with one or more codes, such that each code identifies at least the nature of one or more services provided by, and dictated by, for example, a physician or other healthcare provider. In one or more embodiments, the codes further identify, directly from the physician's voice, the complexity of the provided services or a medical diagnosis.

In one or more embodiments, the inputs are verified against a set of requirements set forth in medical profession accepted standard procedural codes to insure that the generated claim meets certain claim reporting standards in the healthcare industry. Some of these requirements define an identified range of values within which a procedure or a test is to be performed. Others define an identified set of medical terms that comply with the terminology acceptable by the insurance industry or the governmental entities that evaluate claims for medical services and compliance for medical record content.

The system verifies the accuracy of the terms and values provided at the time the data is provided and before the related information is recorded. This is because a claim submitted for a service or procedure that is outside the acceptable parameters or incongruent with standard medical terminology may be denied. In certain embodiments, if the provided data is inaccurate or erroneous the system interactively alerts the user, typically a physician, that the dictated information is outside a set of acceptable terms or values. The system can also provide a prompt for an individual to approve the recorded information and to, for example, terminate the transcription of the patient record by indicating that all requirements have been met.

An exemplary embodiment of the invention may be used or customized for use in a hospital or other healthcare facility. A physician, for example, can utilize the system to dictate physician's orders, progress notes and reports regarding a diagnosis or medical procedure at or immediately after the point of care. The system analyzes the input data, generally provided as a verbal input, to recognize acceptable terms or phrases that relate to a medical procedure or diagnosis. Thereafter, the system searches a database or equivalent data structure to find the CPT and/or ICD codes for the corresponding medical procedure or diagnosis.

The CPT or ICD codes found are recorded in a database or electronic record, the content of which can be processed at a later time to generate billing statements and claims. An embodiment of the system is designed to automatically generate, or feed a system that generates, a report or a claim form based on the completed electronic record. For example, the system can be utilized to generate a medical report as well as to electronically submit a claim for the provided services. Embodiments of the system are also designed to maintain a unique record associated with the provided services based on the completed electronic form and to append that record to a patient database or interface to an electronic medical record file.

While the invention primarily uses verbal input, any of numerous available input methods can be employed including, but not limited to mechanically accepting writing suggestions (clicking on one of several suggestions provided on a computer viewing screen), activating a yes/no selection switch, or any of numerous communication techniques between man and machine or computer known to those skilled in the art.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

FIG. 1 illustrates a block diagram of an exemplary environment in which the system of the current invention may operate.

FIG. 2 illustrates a flow diagram of a method of selecting patient records, in accordance with one or more embodiments.

FIG. 3 is a flow diagram of a method of interacting with the voice user interface of the system to provide verbal input in compliance with a set of requirements, in accordance with one or more embodiments, and perform lookup of CPT and ICD codes.

FIG. 4 is a flow diagram of a method of verifying the accuracy of the provided data for billing purposes, in accordance with one or more embodiments.

FIG. 5 is a flow diagram of a method of generating an electronic claim, in accordance with one or more embodiments.

FIG. 6 is an exemplary graphic user interface (GUI) utilized in conjunction with the voice user interface of the system, in accordance with one or more embodiments.

FIGS. 7 and 8 are exemplary GUIs, in accordance with one or more embodiments, illustrating the suggestive prompting feature of the system.

FIG. 9 is an exemplary GUI, illustrating the Interpretive Linguistic Interface feature of the system, in accordance with one or more embodiments.

FIG. 10 is an exemplary GUI, illustrating an electronic claim form generated by the system, in accordance with one or more embodiments.

FIGS. 11 and 12 are block diagrams respectively illustrating exemplary hardware and software environments, in accordance with one or more embodiments.

FIG. 13 is an exemplary GUI, in accordance with one or more embodiments, illustrating the use of the system for medical orders, progress notes or “free form dictation.”

### DETAILED DESCRIPTION

Information management systems and corresponding methods, according to one or more embodiments of the invention, facilitate and provide electronic voice activated systems and services for generating a claim based on verbal input provided by a human operator.

The terms “electronic services” and “services” are used interchangeably throughout this patent document. A service provider may provide the services of the electronic voice activated system, in one or more embodiments. A service provider is an entity that operates and maintains the computing systems and environment, such as server system and architectures, which process and deliver information. Typically, the server architecture includes the infrastructure (e.g., hardware, software, and communication lines) that offers the services.

In the following, certain embodiments, aspects, advantages, and novel features of the invention have been provided. It is to be understood that not all such advantages may be achieved in accordance with any one particular embodiment. Thus, the invention may be embodied or carried out in a manner that achieves or optimizes one advantage or group of advantages as taught herein without necessarily achieving other advantages as may be taught or suggested herein.

Nomenclature

The detailed description that follows is presented largely in terms of processes and symbolic representations of operations performed by conventional computers, including computer components. A computer may comprise one or more processors or controllers (i.e., microprocessors or microcontrollers), input and output devices, and memory for storing logic code. The computer may also be equipped with a network communication device suitable for communicating with one or more networks.

The execution of logic code (i.e., computer program) by the processor causes the computer to operate in a specific and predefined manner. The logic code may be implemented as one or more modules in the form of software or hardware components and executed by a processor to perform certain tasks. Thus, a module may comprise, by way of example, software components, processes, functions, subroutines, procedures, data, and the like.

The logic code conventionally includes instructions and data stored in data structures resident in one or more memory storage devices. Such data structures impose a physical organization upon the collection of data bits stored within computer memory. The instructions and data are programmed as a sequence of computer-executable codes in the form of electrical, magnetic, or optical signals capable of being stored, transferred, or otherwise manipulated by a processor.

It should also be understood that the programs, modules, processes, methods, and the like, described herein are exemplary implementations and are not related, or limited, to any particular computer, apparatus, or computer programming language. Rather, various types of general purpose computing machines or devices may be used with logic code implemented in accordance with the teachings provided, herein.

System Architecture

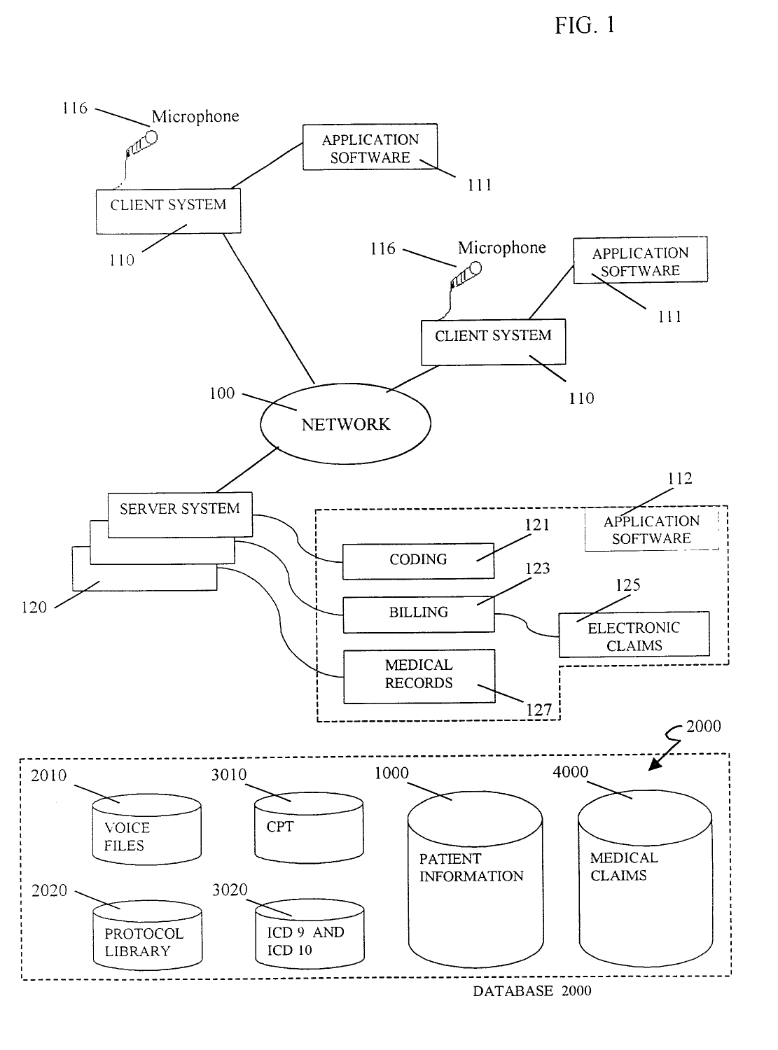

Referring now to the drawings, FIG. 1 illustrates an exemplary system environment in which the invention may operate. In accordance with one embodiment, the environment comprises a communication network 100 connected to one or more client systems 110 and a server system 120. The terms “connected,” “linked,” “coupled,” or any variant thereof, mean any connection or coupling, either direct or indirect, between two or more elements. The coupling or connection between the elements can be physical, logical, via infrared, or a combination thereof.

Client systems 110 can be a computer terminal or other computing system equipped with a microphone 116 or other input device (e.g., keyboard, pointing device, etc.) allowing a user to provide data, preferably in form of verbal input which is converted to one or more electronic signals. The electronic signals are transmitted via communication network 100 from the client systems 110 to server system 120. Server systems 120 may comprise one or more computing systems that interact with database 2000 to maintain and process the provided data. It should be noted that the client-server architecture provided herein is by way of example only. Certain embodiments of the invention may not be implemented in a client-server architecture. That is, in some embodiments client system 110 may operate independently without having to exchange information with a server system 120.

In accordance with one aspect of the invention, client systems 110, server system 120 and database 2000 are connected and communicate via the communications network 100. One of ordinary skill in the art would appreciate that communications network 100 may advantageously be comprised of one or a combination of other types of networks without detracting from the scope of the invention. These networks can include, for example, Local Area Networks (LANs), Wide Area Networks (WANs), a private network, a public network, a value-added network, interactive television networks, wireless data transmission networks, two-way cable networks, satellite networks, interactive kiosk networks, and/or any other suitable communications network.

Depending on implementation, application software 111 and 112 may operate partially or fully on client system 110, server system 120, or both. In one embodiment, application software 111 provides an interactive voice interface that can be utilized by a user to provide voice input to the system. Application software 112, on the other hand, may comprise one or more application software that perform various data processing services as provided in further detail below.

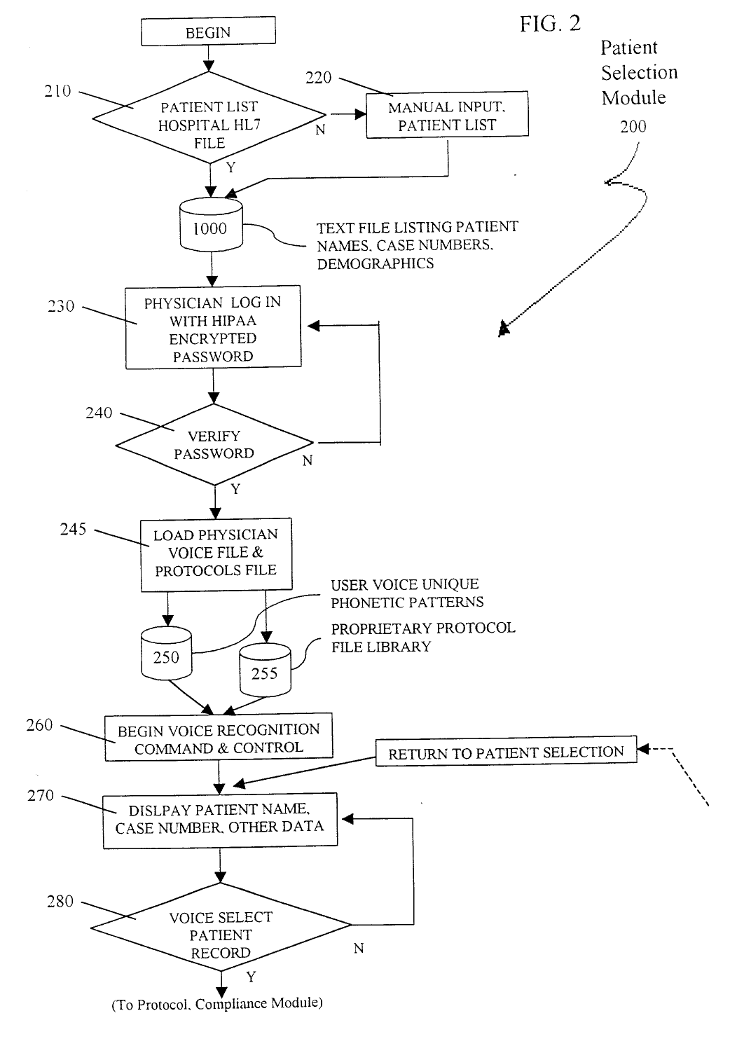

In an exemplary embodiment, the system is utilized in a healthcare facility to generate a claim for services provided to a patient that has been diagnosed and/or treated by a healthcare provider. In such embodiment, application software 112 provides services related to coding 121, billing 123, maintaining medical records 127, and submitting electronic claims 125. Application software 112 may be a collection of one or more modules 200 through 500 as shown in FIGS. 2 through 5. These modules can operate either independently or interdependently to perform the above-mentioned services in accordance with object-oriented or other computer programming concepts.

In some embodiments, the data provided by the user and other information related to the above-mentioned services are stored in a database 2000. Database 2000 may comprise one or more data structures such as a voice file library 2010, a protocol library 2020, a CPT code database 3010, an ICD code database 3020, patient information database 1000, and claims database 4000 as illustrated in FIG. 1.

As discussed in further detail below, the invention in accordance with one or more embodiments is described, by way of example, as applicable to a method of generating a record of a procedure performed on a patient and a claim payment for a patient that has been diagnosed or treated by a healthcare provider. This narrow description, however, is not to limit the scope of the invention to the particular settings within the healthcare industry. One skilled in the art would appreciate that this invention may be practiced in other applicable data processing environments where an interactive voice interface and computing system may be used to access, compile, and report various related information.

Patient Selection Module

FIG. 2 is a flow diagram of a patient selection module 200 illustrating a method of selecting a patient record from a patient information database 1000, in accordance with one aspect of the invention. In order for a healthcare provider to use the system, the healthcare provider needs to access a patient record stored in patient database 1000. In a preferred embodiment, patient records are stored in a particular format known as the Health Level 7 (HL7) format. The HL7 format has been adopted as a standard to provide for a uniform manner of recording and transmitting patient record information by hospitals and insurance payors throughout the United States. Health Level Seven is one of several ANSI-accredited Standards Developing Organizations (SDOs) operating in the healthcare arena. It is a not-for-profit volunteer organization. ANSI is the American National Standards Institute.

In accordance with one embodiment, in a first step 210 the system loads a patient list from the patient database 1000. If a patient list is not stored in the patient database 1000, at a second step 220, a human operator can manually input the needed information to create a patient list. The patient list can be stored in the patient database 1000 if preferred.

At a third step 230 a user such as a physician or other healthcare provider (hereinafter the term “physician” is used for consistency) logs into the system by providing his or her access code, such as a user identification and password. In a preferred embodiment, the password is in compliance with the Health Insurance Portability and Accountability Act (HIPAA) of 1996, enacted to safeguard patient's privacy rights so that all medical information and related data are kept in strict confidence. HIPAA compliance requires 128 kb password encryption, for example. In certain embodiment, the password may be provided by way of a thumbprint, voice, or other user specific input, for example, the keyboard entry of a HIPAA compliant password.

In the verification step 240, the system verifies the password. If the password is incorrect then the system reverts back to the previous step 230 and prompts the physician to try again. Upon successful verification, the system loads the physician's voice and protocol files (loading step 245). The voice file 250 and protocol files 255 are unique to each physician, or groups of physicians with the same specialties. That is, the system is customizable for each physician's practice or hospital based needs.

The unique and customized voice file 250 for each physician is stored in a voice file library 2010, for example. The protocol files 255 for one or more physicians are stored in a protocol library 2020, in accordance with one embodiment of the system. In some embodiments, a user profile file containing each physician's name, specialty, department, electronic signature provisions, auto log out timing and other related information is also stored in a database(not shown). These files together make up a set of individual user files that are loaded at the time a user or physician successfully logs in.

A voice file 250 includes various spoken utterances that match the particular tone, pitch, resonance or other specific audio properties identifying the “phonems” from a physician's voice. The voice file 250 can be created in a well-known manner by the physician during a voice training session, for example. During the voice training session, the physician provides the system with sample audio inputs of his or her voice so that the system learns the particular characteristics of the physician's voice for recognition purposes, and records the physician's phonems, thus creating a physician specific voice file 250.

The protocol file 255 includes the various diagnosis or treatment automated forms that relate to a specific physician's medical specialty. For example, an Ear Nose Throat specialist's protocol file 255 may include protocols for sinus ultrasound and hearing test procedures. A protocol, in accordance with one aspect of the invention, is an electronic form that includes the appropriate language and medical terminology for describing a certain medical treatment, diagnosis, or other health related issue. That is, each protocol includes a preset description of a procedure or diagnosis. This preset description is presented graphically to the physician on a viewable screen and can be modified by the physician to include further details that apply to particular patients.

As further described below, to allow for such modifications, in one embodiment, the written protocol, as viewed by the physician, includes a plurality of blank areas so that the physician can input data into (i.e., populate) each blank area. The added data provides the necessary details that are needed to complete the transcription of diagnosis or treatment related information. Each blank area is associated with a particular field. A field can be a merge field (i.e., automatically populated by the system) or an input field (i.e., needs to be actively completed by user input).

The protocol or automated knowledge base template formats are created from standards published by various national medical specialty societies and boards, chief of staff and department head requirements within individual hospitals, and from samples of the physician's previous transcribed patient records. In one or more embodiments, a protocol comprises a header and five basic elements: line item titles, typical responses or common entries, designated blank response fields with defined properties, designated merge fields, and provision for open dictation.

The above elements may be surrounded by text typically repeated in each procedural description and not provided by verbal input but preset as a part of the body of the protocol. This preset text can be modified by a user during dictation. The format of a protocol, in one or more embodiments, conforms to any standard or outline that applies to the physician's previous pattern of dictated medical records. For example, the header can be patterned after the hospital's customary header for medical records, and can include the name of the hospital, date and time, physician name, and patient name as merged data.

Embodiments of the system are designed to provide for automatic protocol maintenance. For example, an embodiment of the system may allow for automatic download of protocols from the Internet. Alternatively, a physician or other healthcare professional or staff can access a certain site on the Internet to update or download a protocol. In one embodiment of the system, the information entered in a protocol is later processed and compiled by the system to generate billing statements, claims forms, summary reports, patient medical records and other necessary medical documentation, as provided in further detail below.

Once the voice and protocol files for the physician are loaded, the system enters restricted command and control voice recognition mode 260. The verbal input provided by the physician is analyzed to determine which patient record should be retrieved from the patient information database 1000, or to determine which protocol is to be retrieved from the protocol library 2000. The verbal input provided in this mode is recognized if it matches the phonetic pattern of a command in the system's voice recognition vocabulary. The vocabulary comprises terms and phrases provided to the system by the physicians at the time of the voice training and also specially selected medical terms to designate a specific protocol or knowledge base template such as “Bladder Biopsy”.

In the display step 270, the system displays a patient selection menu that includes information, such as patient's name, case number and other related data so the physician can select the appropriate patient record. Patient selection information is, preferably, based upon receiving an HL7 text patient record or other file from a hospital's information system, for example. The content of the HL7 patient record or other data feed can vary based on the capabilities of the hospital information system. Table 1 below illustrates an example of a record extracted from a full information set as available from a typical hospital system.

TABLE 1

Name Last: Smith
Name First: John
Medical Record Number: 1234-987654
Case Number: 1234567890
DOB: June 22, 1946
Accession Number: 22
Sex: M
Account Number: 876-54345

In some embodiments, an HL7 patient record includes the patient name, medical record number, case number, birth date, sex, ascension number and other needed information that are parsed from the hospital's HL7 message record or other data file. Additional information found in an HL7 message or patient record such as street address is generally not displayed by the patient selection menu, but is stored for inclusion in medical records or statements at the time of billing or compiling patient data.

The physician provides a voice input (i.e., voice command) or uses other input device to select a patient's record from the list (patient selection step 280). This selection is accomplished, for example, by either speaking the number of the patient in the list (1 through n), or the last four digits of the case number, or other patient reference number. In certain embodiments, commands such as “sort by number,” “display case numbers,” “sort by name,” “list patients,” or “display names” can be utilized by the physician to sort and re-display the list of cases or patients.

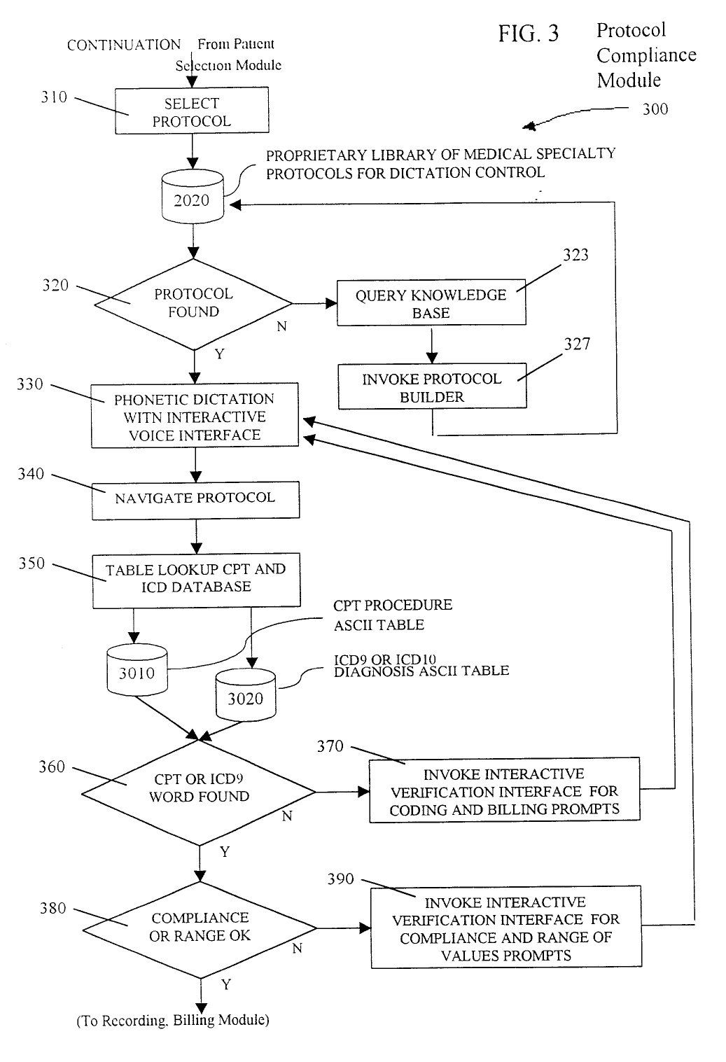

When a patient is selected either by, for example, case number or his number in the list, the balance of the demographic information available for that patient is displayed preferably in the center of the screen. This full set of information for a specific patient will serve as a final graphic verification that the correct patient has been selected. The physician may reaccess the patient list and provide a display or sort command such as “display names” or “case list” if it is noted that the wrong patient has been selected. If a voice input provided by the physician is not recognized in the command and control voice recognition mode, or if a requested record is not found, the system reverts back to the display step 270 and prompts the physician for additional input. Otherwise, the system's operation continues as illustrated in FIG. 3 and as provided in further detail below.

Protocol Compliance Module

FIG. 3 is a flow diagram of a protocol compliance module 300 illustrating a method of verifying verbal input in compliance with a set of requirements. Once a physician has successfully selected a patient record, the physician selects a protocol from a list of protocols provided by the system (the protocol seek step 310). This list of protocols is stored in a protocol library 2020 that comprises a proprietary collection of medical specialty protocols, otherwise referred to as “automated forms” or “knowledge base templates”.

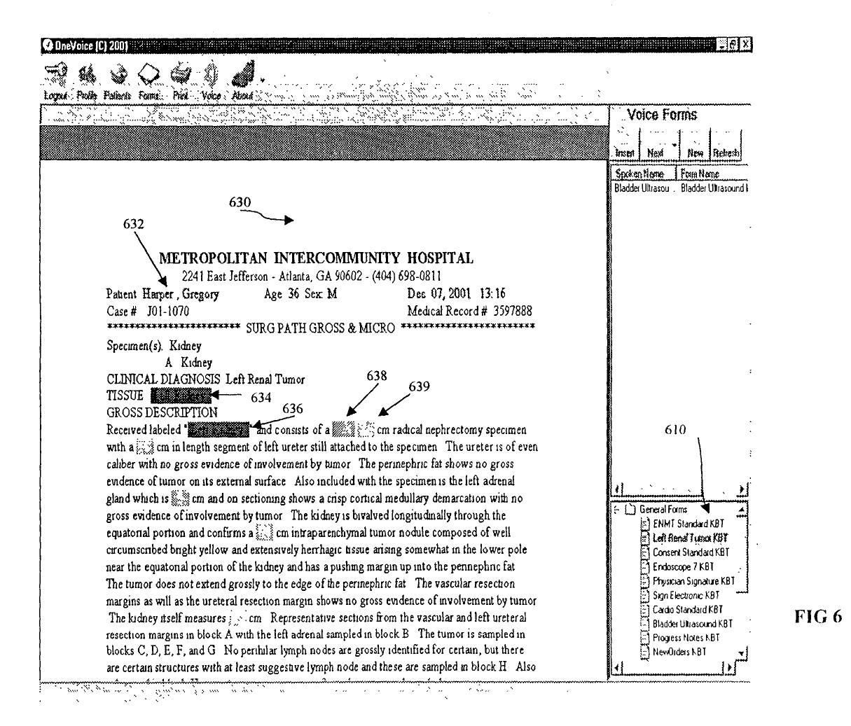

FIG. 6 is a graphical user interface (GUI), in accordance with one aspect of the system, illustrating a list of protocols 610. The system's knowledge base includes protocols directed to various treatments and diagnosis in different medical specialties, in addition to common and general medical treatments and diagnosis. For example, as illustrated in FIG. 6, the protocol list 610 includes ENMT Standard KBT (Knowledge Based Template), Left Renal Tumor KBT, Consent Standard KBT, Endoscope 7 KBT, Bladder Ultrasound KBT, etc. These protocols are related to urological medical treatments and procedures and Pathology reports and are thus displayed when a urologist or Pathologist signs on to the system, for example.

Referring back to FIG. 3, once the physician has provided a verbal input to select a protocol, (the protocol selection step 320) it is determined if the protocol is found in the list 610. If the protocol is not listed, a query 323 of the system knowledge base protocol library 2020 is performed, for example, to determine if the requested protocol can be loaded. The physician may invoke a protocol builder 327. The protocol builder 327 allows the physician to directly create an entirely new protocol, or to modify an existing protocol in protocol library 2020. As such, the physician can add a new or customized protocol to protocol library 2020 and store it for future use.

Once the physician has selected a protocol the physician can begin the dictation step 330 (i.e., provide verbal input) using the interactive voice interface of the system, via a voice input device such as microphone 116. Application software 111 is executed on a client system 110 to provide the interactive voice interface. The interactive voice interface preferably includes a voice recognition engine for interpreting the provided verbal input and additional logic necessary to accept or reject a recognized input for a certain field in the protocol. The advantage of using a protocol such as that shown in FIG. 6 (e.g., left renal tumor) is that the physician does not have to dictate the entire body of text that describes a diagnosis or procedure. The protocol contains the essential majority of the often repetitive language, for describing a particular diagnosis or procedure with the exception of a few descriptive fields unique to each patient.

For example, the Surge Path Gross & Micro protocol 630 contains text that includes both the gross and microscopic description of a clinical diagnosis for a left renal tumor biopsy. Certain fields such as, for example, patient first and last name, age, sex, date and time are blank. These fields (also referred to as merge fields) are automatically populated based on information stored in patient information database 1000 and system settings, as soon as the protocol is loaded from protocol library 2020. The automatic population of the merge fields by the system advantageously reduces dictation time and promotes accuracy.

In certain embodiments, merge fields are designated by a standard color (e.g., yellow). Other fields for physician supplied information, such as fields 634, 636, and 638 are completed using verbal input provided by the physician. To distinguish fields for physician input 634, 636, 638 from the merge fields, the fields are identified by a color (e.g., blue) other than that used to identify the merge fields. One skilled in the art would appreciate that embodiments of the system incorporate background colors, shading, animation and other techniques common to attractive graphic design to emphasize and promote interactive efficiency along with user comprehension and comfort.

Referring back to FIG. 3, at the dictation step 340, the physician navigates the protocol, using control verbal commands, such as “forward,” “back,” “next” and “previous,” for example, to move from one field to the next or with an auto-advance feature advances from a field where data is entered to the next blank field. A list of exemplary control verbal commands, in accordance with one aspect of the invention, is provided in Appendix B. Once a field is selected, the physician preferably visually reviews the text included in the protocol and provides a verbal input that corresponds to that field.

Referring to FIG. 6, for example, when a first field 634 is selected the physician may say “left kidney” or the name of a body organ that is the subject of the clinical diagnosis. Other fields 636, 638, 639, can be filled in the same manner. In alternative embodiments, the physician can use other input devices such as the keyboard or a pointing device to select a field or input data. As provided earlier, in some embodiments, various fields are graphically presented in different manners (e.g., different colors) so they can be easily distinguished from one another, as for example green indicating grams, blue indicating centimeters and gray indicating length.

In order for a verbal commands input to be accepted as input into a field, it should comply with a set of requirements. These requirements, in one or more embodiments, define both linguistic and statistic limitations. A linguistic limitation, for example, restricts the system to accept a verbal input that matches a certain set of terms or phrases. That is, a verbal input is accepted (i.e., recognized) if the verbal input's phonetic pattern matches the phonetic pattern of a term included in the physician's voice file 2010, for example.

A statistic limitation, for example, restricts the system to accept verbal inputs that are within a predetermined numeric range or match a predetermined set of values. That is, even if a verbal input for a particular field is recognized linguistically it may be rejected statistically if it fails to match an acceptable set of values. As such, the system comprises a voice interface that interactively monitors the data verbally provided by a human operator to selectively accept verbal inputs that are appropriate within the context of a respective protocol or a field within the protocol.

Referring back to FIG. 3, after the system receives a verbal input, at the search step 350, it performs a lookup operation to try to match the audio input with one or more terms or phrases in the CPT or ICD databases 3010, 3020. The CPT and ICD databases may be implemented as lookup tables or any other data structure that can be efficiently searched. Further, the content of the CPT and ICD databases 3010 and 3020 can be regularly updated as needed.

At a matching step 360, the system then determines whether a match is found. If the system does not find a match for the verbal input, the system invokes an interactive verification interface 370 for coding and billing prompts or compliance prompt if applicable, alerts the physician and reverts back to the dictation step 330 to continue with the dictation. This interactive interface in conjunction with the system's knowledge base software provides the physician with interactive prompts to assist him or her to provide an acceptable verbal input for a respective field, as provided in further detail below. If a match is found, the system continues to the range compliance step 380, discussed below.

In one embodiment, for example, the knowledge base comprises the combination of ICD codes necessary to support the use of a particular CPT or set of CPT codes. The system uses the information in the knowledge base to verify the accuracy and appropriateness of an input by determining if the input corresponds to, for example, a three digit designation included in an entry in the ICD database 3020. If the input corresponds to more digits, then the system will prompt the physician to select or acknowledge a keyword which corresponds to the provided input. For example, a diagnosis wording entry by the physician of “urosepsis” results in a lookup from the ICD database indicating a billable code of “599.0”, but will also result in prompting for diagnosis coding and support of the billing. The system may display, for example “urinary obstruction” with a corresponding four digit ICD code “599.6” or “urethral instability” with a corresponding five digit ICD code “599.83” from the ICD database. The larger number of significant digits, not ending in 0 in the ICD code may result in a more appropriate and higher reimbursement amount.

In one embodiment, the knowledge base content for verbal input validation is automatically expanded by creating aliases for terms and phrases that result in common errors and omissions in dictation. For example, if a physician commonly uses the term “sepsis” to refer to the term “urosepsis,” then the system's knowledge base is trained to automatically correct an audio input for “sepsis” and prompt an entry for “urosepsis” or “chronic salpingitis” to be verified (accepted) by the physician. As such, in an embodiment of the system, a listing of terminology in common use by one or more physicians in a particular hospital, but not corresponding to ICD or CPT code words is included in an alias database. The content of the alias database is then consulted by the system or added to the knowledge base so that common dictation errors can be progressively reduced.

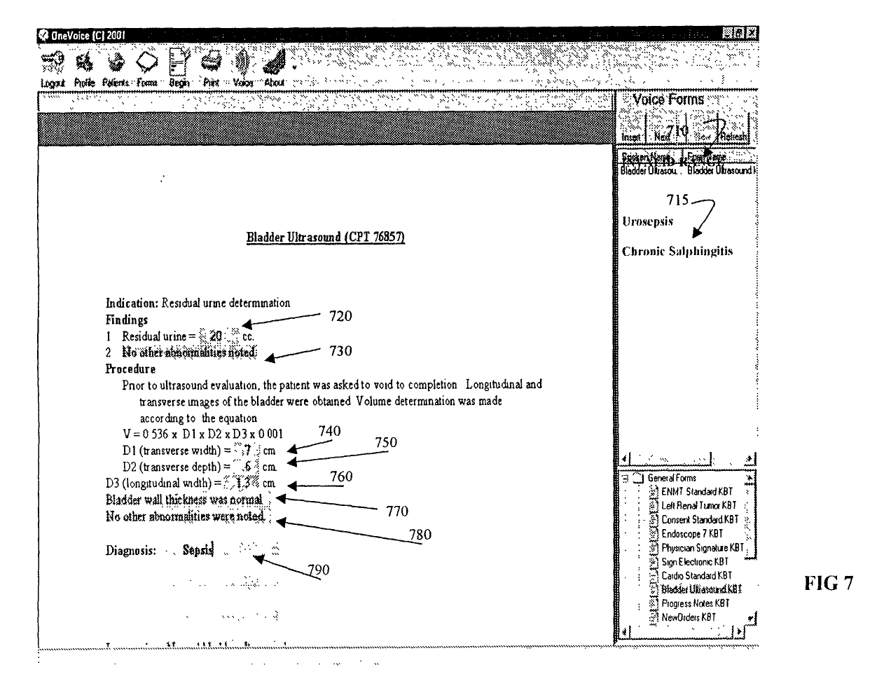

Referring to FIG. 7, an exemplary GUI, illustrating a bladder ultrasound protocol in accordance with one or more embodiments of the system is provided. As shown, various fields 720, 730, 740, 750, 760, 770,780 are filled by the physician as the result of the physician's interaction with the voice user interface of the system or acceptance is indicated by the physician of default text shown in the field. The provided verbal input is converted into text by the system's voice recognition engine and is included in the corresponding fields. The diagnosis field 790 includes the term “sepsis.” In this example, since the term “sepsis” is not a term found within the CPT or ICD databases 3010, 3020, the system provides the physician with an alert prompt (e.g., “invalid range”) in an alert window 710.

The alert prompt 710 notifies the physician that the verbal input provided is not accepted by the system. In certain embodiments, in addition to the alert prompt 710, the system also provides a suggestion prompt 715 that includes one or more acceptable terms from which the physician can choose. For example, as illustrated in FIG. 7, the system prompts the physician to say “urosepsis” or “chronic salpingitis” because the term “sepsis” is not an acceptable input term.

As such, the system includes an intelligent knowledge base that helps determine which input terms or phrases are appropriate within the context of a protocol or a field within the protocol. For example, if within the context of a protocol the appropriate input is an ICD word or phrase, then the system searches ICD database 3020 for a match for the verbal input. If a match is not found, then at the dictation step 330 (FIG. 3) the physician can provide a new verbal input by way of phonetic dictation. If the system has provided a suggestive prompt, the physician may select one of the suggested terms or phrases instead. Alternatively, the physician can override the system's prompts and force the unacceptable term to be input into the field.

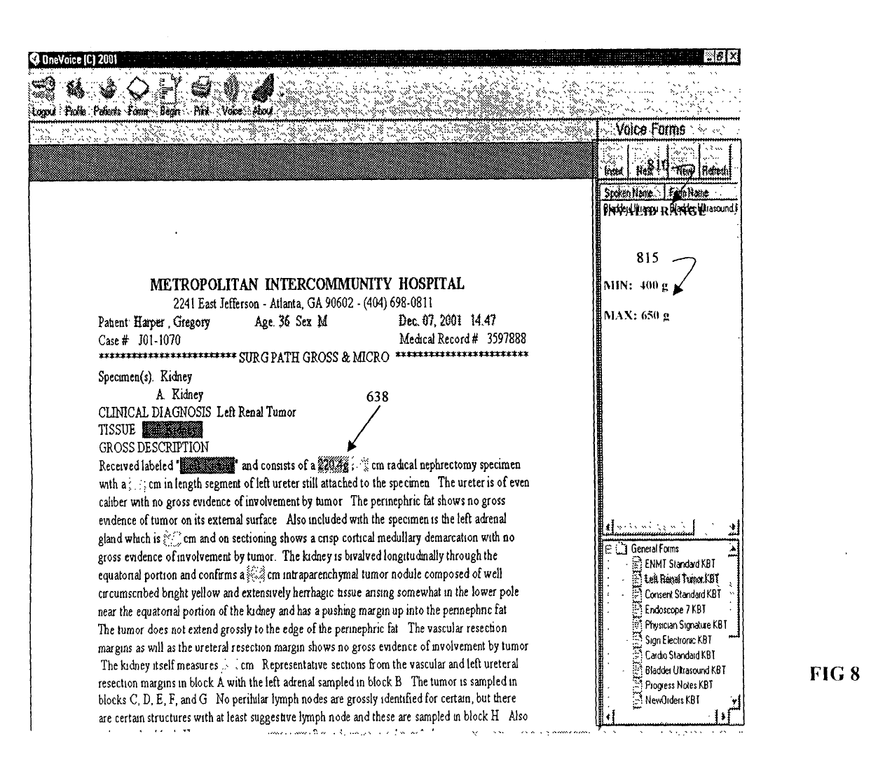

At the compliance step 380, the system determines if the provided input is within an acceptable range. For example, referring to FIG. 8, in providing the gross description for a left renal tumor clinical diagnosis the physician may provide a verbal input that indicates that “220.4 grams” of a particular specimen were tested. After receiving this input, the system consults the knowledge base to determine if the provided value (e.g., the weight of specimen) complies with a set of requirements, typically, dictated by the payers (e.g., insurers or government). If the provided value is not appropriate, then the system invokes the system's interactive verification interface 390 for compliance requirements and range of values prompts and reverts to the dictation step 330.

For example, in the exemplary GUI illustrated in FIG. 8, the system prompts the physician (e.g., by way of an alert window 810) with an alert prompt indicating, for example, that the provided input is within an “invalid range,” for compliance, code, or reimbursement purposes. In certain embodiments, in addition to providing both the sound (.wave file or text-to-voice) and displayed alert prompt, the system also provides suggestive prompts 815 that indicate the acceptable range for the input. As shown in the example of FIG. 8, the acceptable range for the particular field is suggested as being between “400 grams” and “650 grams.” Once the alert or suggestive prompt is displayed, the physician has three choices at the dictation step 330. The physician can either try again to provide another verbal input, or can provide a verbal input that is within the range suggested by the system, or can alternatively override the system's alert prompt and force the system to accept the initial input.

Thus, the system includes a series of interactive interfaces that, depending on implementation, provide the physician with various alerts or suggestive prompts to ensure appropriate linguistic and statistic data entry into each field in a protocol. The prompting is discrete so that the privacy of the physician is maintained even if the physician is using the system in a public area. This system provides multiple benefits. First, it identifies transcription errors during dictation. Second, if the dictated input is correct, it alerts the physician that the procedure performed may not meet acceptable clinical standards, so he can repeat the input. The interactive linguistic interface also invokes knowledge base software nodes and software cubes based upon the recognition of key words that result in additional functions during dictation such as researching a patient's electronic medical record, pharmaceutical interaction tables, or dialing out to the CDC for further information to prompt the physician during dictation.

The verification process 360, 370, 380, 390 advances clarification and accuracy at the point of care. This verification process not only promotes accurate and timely dictated records, it also eliminates the need for labor intensive and expensive transcription services that are currently used by many healthcare providers. Further, real-time verification and concurrent prompting at the point of care force the physicians to review and correct dictation that does not support proper codes required for billing and claim reporting and compliance requirements. Other advantages include the possibility of same-day billing and substantial reduction in the possibility of errors and omissions in dictated medical records.

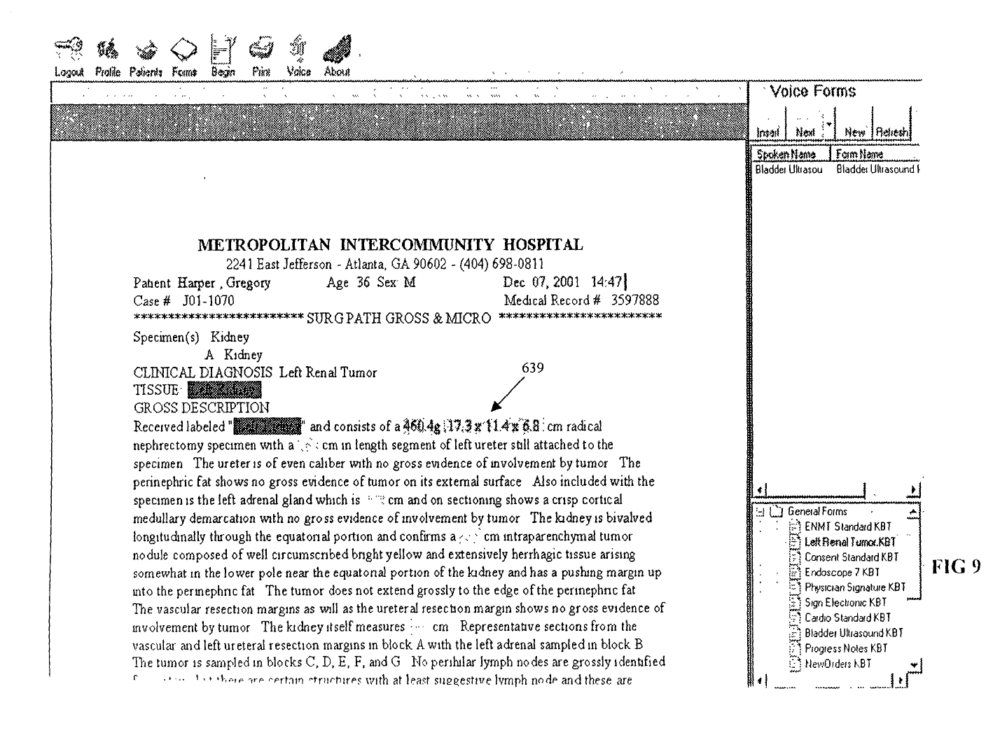

To eliminate transcription, the system also includes an interpretive linguistic interface. These embodiments of the system are also designed to automatically correct certain input in compliance with a set of requirements without prompting the physician to repeat the verbal input. For example, referring to FIG. 9, dimensional field 639 is used to provide the dimensions of a specimen used in a clinical diagnosis of a left renal tumor. A physician when dictating may provide an audio input such as “17.3 by 11.4 by 6.8” to describe the dimensions of the specimen. The system's knowledge base has the intelligence to convert this input to appear as “17.3×11.4×6.8” automatically, for example. The interpretive linguistic interface results in correct presentation of standard medical nomenclature.

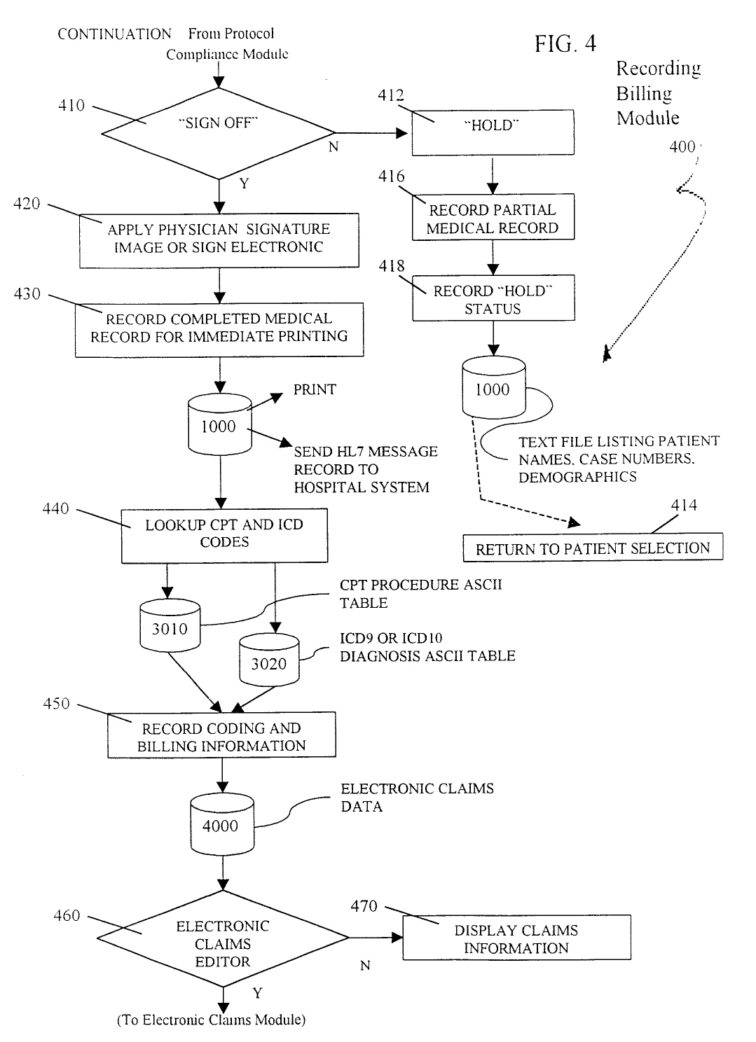

Once the system has verified the input information in the protocol for correctness and accuracy within the context of each field and/or protocol, the physician can provide a verbal command to move to the next field. Alternatively, as further provided below (FIG. 4), the physician can request to sign off or hold the dictation for later completion.

Recording Billing Module

FIG. 4 is a flow diagram of a recording and billing module 400, in accordance with one embodiment of the system. At sign off step 410, the physician may end the dictation session by signing off from the system. Alternatively, if the physician for some reason has not completed the electronic automated form or knowledge base template provided with each protocol he may pause dictation by requesting a hold state 412.

Once the system enters the hold state 412 then the system makes a recording of the partial medical record 416 in a patient information database 1000, for example. The system also marks the incomplete medical record by identifying a hold status 418 for that record. This can be accomplished, for example, by setting a flag that distinguishes a held record from a completed record. A physician can later revisit the incomplete medical record by activating the return 414 to the patient selection step 270 shown on FIG. 2

In some embodiments, the system may not enter a sign off state, unless all fields designated mandatory fields in a protocol have been filled or populated. In some embodiments, a standard color (e.g. red) is designated to visually identify all mandatory fields. If a mandatory field is not filled during dictation, the system graphically and/or audibly notifies the physician of the omission before allowing the physician to sign off. A record without all mandatory fields populated may be placed in a hold status by the system automatically with a notification to the physician to later provide the required information.

If the system is advanced to the sign-off status instead of the hold-status 412, then the system applies the physician's signature image or an electronic signature to the completed medical record created from the dictation session (signature step 420). One skilled in the art would appreciate that alternative methods for authenticating the originality of the medical record may be used in accordance with other well-known methods in the industry, such as verification through thumbprint image at the completion (“sign off”) of each dictated record.

After the signature step 420, the system records the completed medical record in the patient information database 1000 or other databases that store patient medical records and related information (the storage step 430). Once the medical record is stored, it is ready for immediate printing. That is, a hard copy of the electronic form (i.e., the dictated protocol) can be printed and also stored in the patient information file 1000. Further, the system formats the recorded information into the HL7 or other well-known record format for transmission to other databases or nodes within the healthcare facility.

The advantage of formatting the medical record into a standard format is that information included in the record can be easily accessed and analyzed by other computing systems. For example, an independent computing system can be used to retrieve patient records and print medical records and billing statements. Another independent computing system can be used to print patient charts or perform an analysis of patient care.

Once the dictated record is recorded, the system analyzes the input data in each record and records the corresponding CPT and ICD codes for that record (look-up step 440). As provided earlier, the CPT and ICD codes for each procedure or diagnosis are needed for billing and claim reporting purposes and may be looked up concurrently during dictation or following the completion of dictation. The CPT or ICD codes can be determined by searching the CPT and ICD databases 3010, 3020. The CPT and ICD databases may include lookup tables, for example, that cross-reference each medical term or phrase with the respective CPT or ICD code. One skilled in the art would appreciate that any other well-known data structures or search and retrieve method may be used to select the respective codes for each term or phrase.

The system then records the coding and billing information (recording step 450) gathered from analyzing the dictated medical records in a claims database 4000. This information can be used at any later time by the current system or other independent claim reporting systems to generate and submit medical claim forms in print or electronically, for example. If a physician, at the time of dictation, has provided audio input that can be appropriately matched with a respective CPT or ICD code, then a complete claim form can be generated and submitted. Otherwise, if for example the physician has used the override feature to enter non-standard information, the claim information needs to be edited in order to provide the missing or supporting information.

An electronic claims editor 460 is then invoked. The electronic claims editor 460 can be used by a human operator, for example, to review and verify information entered at the time of dictation. If appropriate or needed, the recorded coding and billing information can be assembled into a data structure (e.g., text file or database) for immediate display. In this manner, the claim information can be displayed at display step 470 without having to invoke the claims editor. This feature of the invention is helpful in circumstances where individuals experienced in medical billing can quickly review a claim displayed on a computer screen and decide immediately to transmit the claim to Medicare or other insurance payors.

Once the electronic claim editor 460 is invoked, claim information may be reviewed and modified using the interactive user interface feature of the system, as provided in further detail below.

Electronic Claims Module

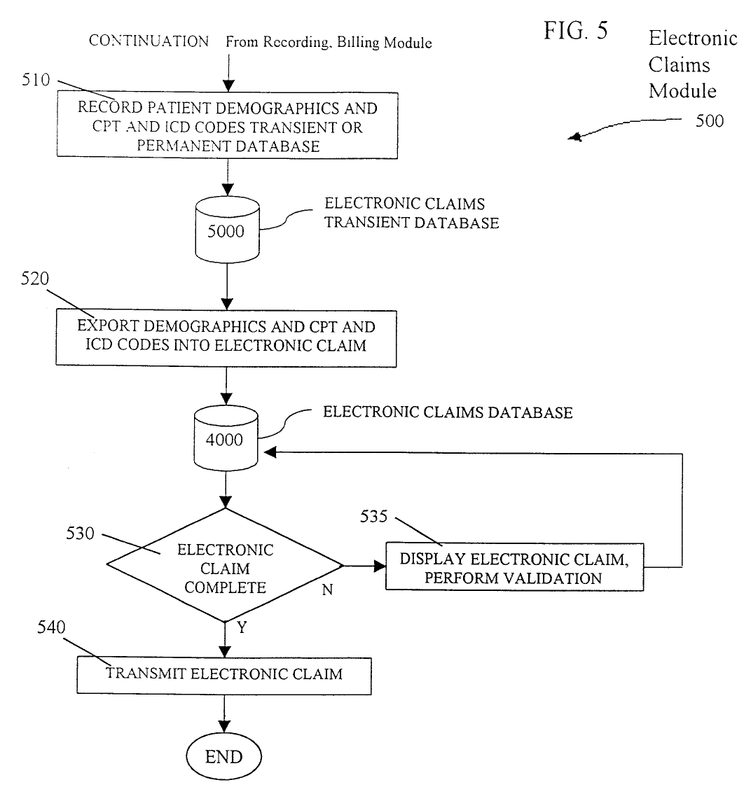

FIG. 5 is a flow diagram of an electronic claims module 500, in accordance with one embodiment of the system. The patient demographics and the CPT and ICD codes for a claim are recorded 510 in a transient claims database 5000. Patient information and the CPT and ICD codes that correspond with a treatment or diagnosis reported in a medical record are necessary to submit a claim for payment.

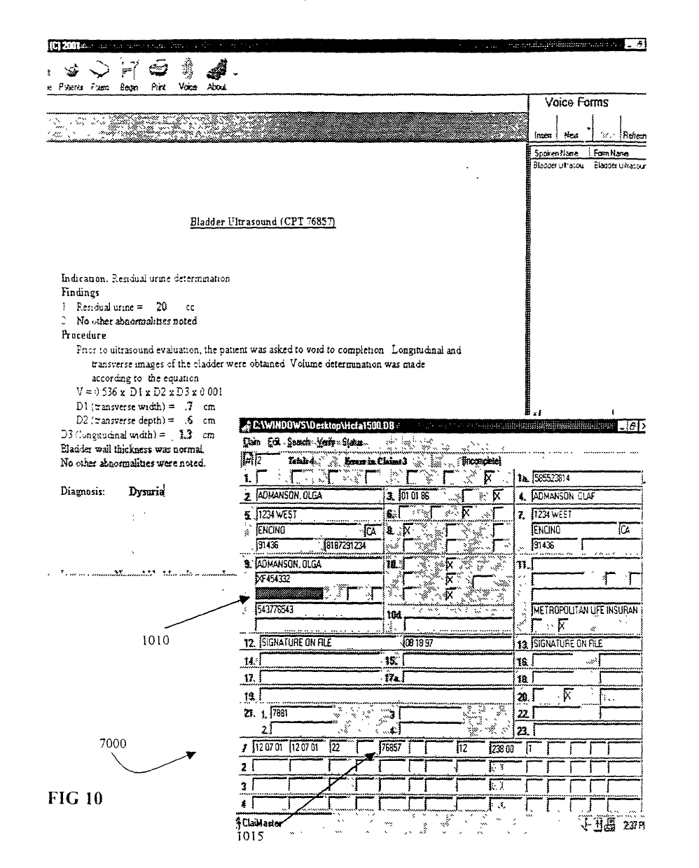

In accordance with one aspect of the invention, the physician office or hospital billing staff can use the system to generate either a paper claim form by printing the information included in the transient database 5000 or a human operator can use the system to populate an electronic claim form 7000, such as that illustrated in FIG. 10. As shown, electronic claim form 7000 once populated will include patient demographic information, such as social security number, first name and last name, date of birth address and other relevant information included in the patient's medical record.

Any field for which required information has not been provided or is unavailable appears as a blank field 1010. In certain embodiments, if the missing information is mandatory for the submission of a claim, that field is highlighted or otherwise graphically promoted over the other fields. In this manner, a human operator reviewing the claim for correctness and accuracy easily notices the field with the missing information without having to manually enter all other information.

In addition to the patient information, the electronic claim form is also populated with the CPT and ICD codes recorded from each dictated protocol. For example, referring to FIG. 10, claim form 7000 includes CPT code “76857” in the code field 1015. This indicates that the claim submitted for the patient “Adamson, Olga (a fictitious name)” is for a bladder ultrasound procedure, for example.

The information recorded in the transient claim database is then (export step 520) transferred into an electronic claims database 4000 that is used to store generated claims from hospitals, physicians and healthcare providers. The system then retrieves completed electronic claims from the claims database 4000 (retrieval step 530). If a claim is incomplete or does not meet the requirements “payor specific edits” of a particular insurance payor, the system displays the electronic claim form for validation (validation display 535). Preferably, a human operator reviews the claim form for completion and accuracy and approves it for transmission. The system completes the process electronically transmitting the completed electronic claims to the appropriate claim processing centers (transmission step 540).

Referring to FIG. 1, in accordance with one aspect of the invention, application software 111 and 112 are executed on client systems 110 and/or server systems 120 or other computing systems. Referring also to FIGS. 2 through 5, application software 111 and 112 comprise logic code that includes one or more of the above discussed modules. These modules may execute on one or more processors in a distributed or non-distributed communication environment. The modules, methods, and actions provided herein need not necessarily execute on a particular computing system or order.

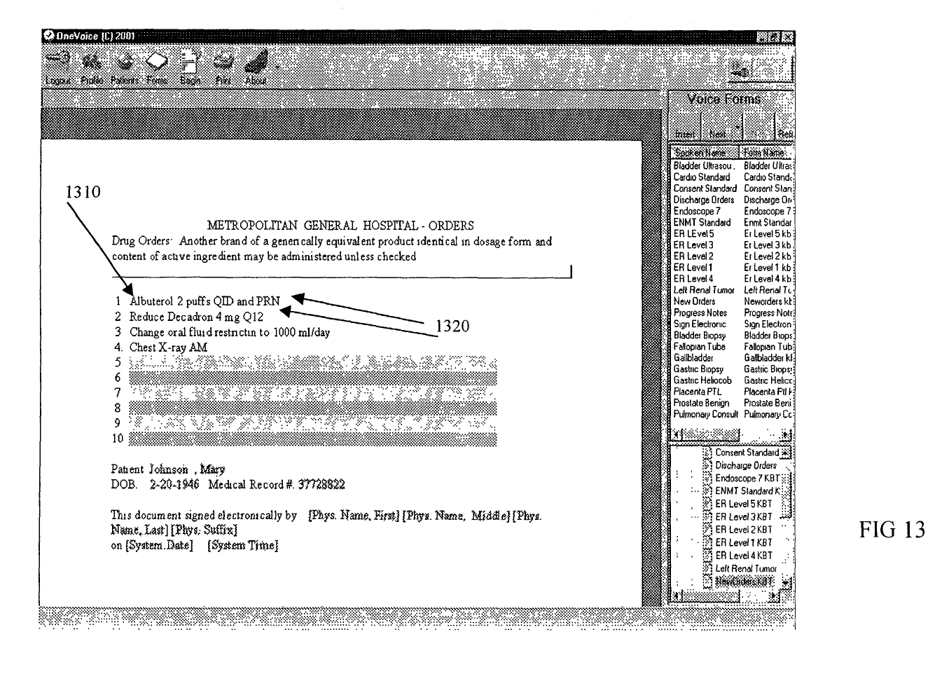

One skilled in the art of software engineering would appreciate that the order in which the actions or steps in the present methods and modules are performed is purely illustrative in nature. Depending on implementation, the steps can be performed in any order or in parallel, unless specifically indicated otherwise by the present disclosure. For example, in the exemplary GUI illustrated in FIG. 13, the system will prompt the physician during dictation of medical orders, progress notes, or other chart notes depending upon the system's analysis of each key word 1310 or combination of key words 1320, compliance requirements, and ranges of values input during dictation.

The methods of the present invention may be performed in either hardware, software, or any combination thereof, as those terms are currently known in the art. In particular, the provided methods may be carried out by software, firmware, or macrocode operating on a general computer or a computing system of any type. Additionally, software embodying the present invention may comprise computer instructions in any form (e.g., ROM, RAM, magnetic media, punched tape or card, compact disk (CD) in any form, DVD, etc.). Accordingly, the present invention is not limited to any particular platform, unless specifically stated otherwise.

Hardware & Software Environments

In accordance with one or more embodiments, the system is composed of two environments, a software environment and a hardware environment. The hardware includes the machinery and equipment that provide an execution environment for the software. On the other hand, the software provides the execution instructions for the hardware.

The software can be divided into two major classes including system software and application software. System software includes control programs, such as the operating system (OS) and information management systems that instruct the hardware how to function and process information. Application software is a program or series of programs that perform specific tasks. As provided herein, in embodiments of the invention, system and application software can be implemented and executed on one or more hardware environments.

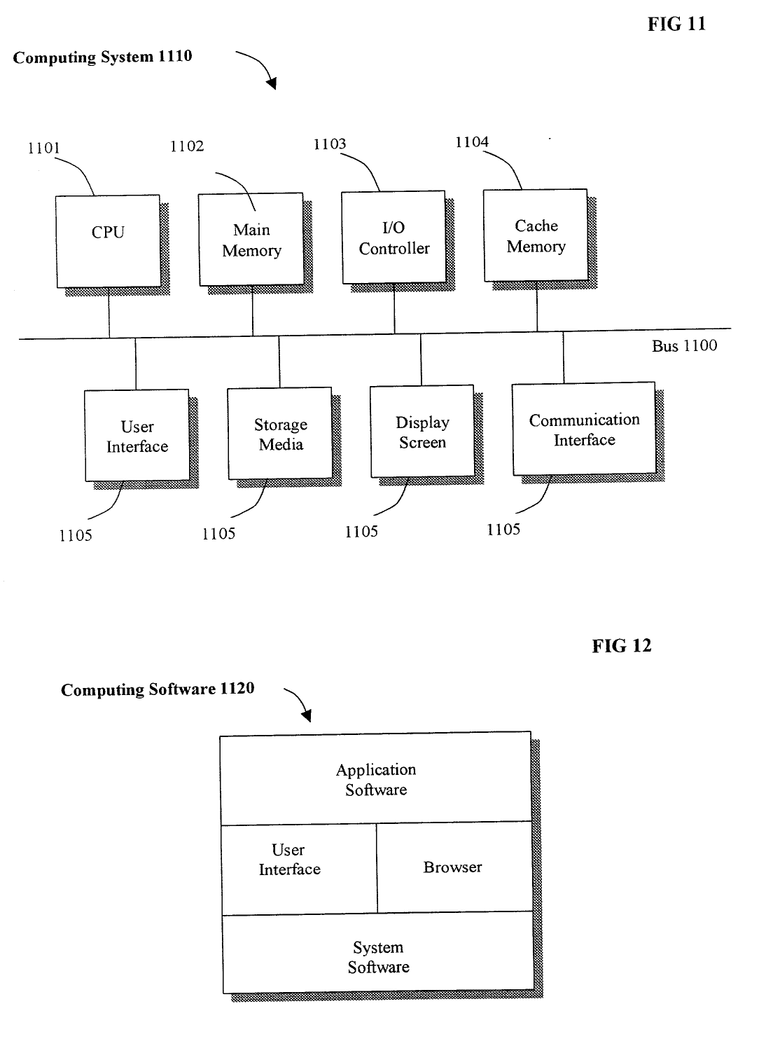

The present invention may be practiced either individually or in combination with suitable hardware or software architectures or environments. For example, referring to FIG. 1, client systems 110 and server systems 120 may be general-purpose computers such as computing system 1110 illustrated in FIG. 11. Application software 111, 112 may comprise one or multiple application software modules 1122 that operate on top of a system software 1121 in the manner illustrated in FIG. 12. In some embodiments, it may prove advantageous to construct a specialized apparatus to execute said modules by way of dedicated computer systems with hard-wired logic code stored in non-volatile memory, such as, by way of example, read-only memory (ROM).

Hardware Environment

An embodiment of the system comprises application software 111, 112 in the form of computer readable code executed on a general purpose computing system 1110. Computing system 1110 includes a central processor unit (CPU) 1101, a main memory 1102, an input/output controller 1103, optional cache memory 1104, user interface devices 1105 (e.g., keyboard, pointing device, etc.), storage media 1106 (e.g., hard disk, CD-ROM, etc.), a display screen 1107, and a communication interface 1108 (e.g., an integrated services digital network (ISDN) card, dial-up modem, etc.). A communication bus 1100 is utilized to promote communication between the above system components. Computing system 1110 may be capable of communicating with other systems through communication interface 1108.

In one or more embodiments, computing system 1110 may not include all the above components, or may include additional components for additional functionality or utility. For example, computing system 1110 can be a laptop computer or other portable computing device that can send messages and receive data through communication interface 1108. Computing system 1110 may be partially or fully embodied in an embedded system such as a set-top box, a personal data assistant (PDA), a wireless communication unit (e.g., cellular phone), web televisions, or other similar hardware platforms that have information processing and/or data storage capabilities.

Communication interface 1108 can send and receive electrical, electromagnetic, or optical signals that carry digital data streams representing various types of information including logic code. The logic code is executed by central processor unit 1101 or is stored in storage media 1106 or other non-volatile storage for later execution. Logic code may be transmitted via a carrier wave or may be embodied in any other form of computer program product. In one or more embodiments, processor 1101 is a microprocessor manufactured by Motorola, Intel, or Sun Microsystems corporations. The named processors are for the purpose of example only. Any other suitable microprocessor, microcontroller, or microcomputer may be utilized.

Software Environment

FIG. 12 illustrates exemplary computer software 1120 suited for managing and directing the operation of the hardware environment described above. Computer software 1120 is, typically, stored in storage media 1106 and is loaded into memory 1102 prior to execution. Computer software 1120 may comprise system software 1121 and application software 1122. System software 1121 includes control software such as an operating system that controls the low-level operations of computing system 1110. In one or more embodiments of the invention, the operating system is Microsoft Windows 2000, Microsoft Windows NT, Macintosh OS, UNIX, LINUX, or any other suitable operating system may be utilized.

Application software 1122 can include one or more computer programs, such as application software 111, 112 that are executed on top of system software 1121 after being loaded from storage media 1106 into memory 1102. In a client-server architecture, application software 1122 may include a client software 111 or a server software 112. Referring to FIG. 1 for example, in one embodiment of the invention, client software 111 is executed on client system 110 and server software 111(b) is executed on server system 120. Computer software 1120, in addition, may include a user interface 1124 for receiving user commands and delivering content to a user and a browser software 1126 for connection to the Internet. Application software 1122 can also operate from a server through a “thin client” connection to a server computer.

Thus, a method and system for automatically processing and verifying verbal input for compliance, proper completion of medical records, and medical insurance including workman's compensation claims reporting purposes are provided. The embodiments described above are to be considered in all aspects as illustrative only and not restrictive in any manner. Other exemplary embodiments, system architectures, platforms, and implementations that can support various aspects of the invention may be utilized without departing from the essential characteristics described herein. These and various other adaptations and combinations of features of the embodiments disclosed are within the scope of the invention. The invention is defined by the following claims and their full scope of equivalents.

[image]

[image]

[image]

[image]

[image]

[image]

1. A method for automatically processing verbal input, the method comprising:
providing an interactive voice interface for receiving and analyzing one or more verbal inputs defining one or more terms, wherein the one or more verbal inputs if accepted are used to fill one or more corresponding fields in an electronic form;
accepting a first verbal input for a corresponding first field, if the first verbal input complies with a set of requirements;
prompting for a second verbal input, if the first a verbal input is not accepted;
continuing to receive and analyze further verbal inputs until the electronic form is completed;
associating the electronic form with one or more standard industry codes, wherein said one or more standard industry codes can be used to identify the one or more terms defined by the one or more verbal inputs; and
arranging said one or more standard industry codes in a predetermined manner to generate a transmittable claim for reimbursement that can be processed by a processing facility.

2. The method of claim 1 wherein the act of prompting comprises suggesting one or more acceptable choices.

3. The method of claim 1 wherein the one or more standard industry codes identify at least a medical diagnosis.

4. The method of claim 1 wherein the one or more standard industry codes identify at least a medical service.

5. The method of claim 1 wherein the set of requirements define an identified range of acceptable values.

6. The method of claim 1 wherein the set of requirements define an identified set of acceptable medical terms.

7. The method of claim 1 wherein the one or more standard industry codes are CPT codes.

8. The method of claim 1 wherein the one or more standard industry codes are ICD codes.

9. The method of claim 1, further comprising automatically prompting for correct verbal input to comply with a predefine format.

10. The method of claim 1, wherein the prompting for the second verbal input comprises providing one or more suggestions for the second verbal input.

11. A system for automatically processing verbal input, the system comprising logic code configured for execution by a processor, wherein execution of the code causes the system to
a) provide an interactive voice interface for receiving and analyzing one or more verbal inputs defining one or more terms, wherein the one or more verbal inputs if accepted are used to fill one or more corresponding fields in an electronic form;
b) accept a first verbal input for a corresponding first field, if the first verbal input complies with a set of requirements;
c) prompt for a second verbal input, if the first verbal input is not accepted;
d) continue to receive and analyze further verbal inputs until the electronic form is completed;
e) associate individual words within the electronic form with one or more industry standard codes, wherein said one or more industry standard codes can be used to identify the one or more terms or code numbers defined by the one or more verbal inputs; and
f) arrange said one or more industry standard codes in a predetermined manner to generate a claim for reimbursement that can be processed by a processing facility.

12. The method of claim 11, further comprising logic code configured for execution by a processor, wherein execution of the logic code causes the system to suggest one or more acceptable choices.

13. The method of claim 11 wherein the one or more industry standard codes identify at least a medical diagnosis.

14. The method of claim 11 wherein the one or more industry standard codes identify at least a medical service.

15. The method of claim 11 wherein the set of requirements define an identified range of acceptable values.

16. The method of claim 11 wherein the set of requirements define an identified set of acceptable medical terms.

17. The method of claim 11 wherein the one or more industry standard codes are CPT codes.

18. The method of claim 11 wherein the one or more industry standard codes are ICD codes.

19. The method of claim 11, wherein execution of the logic code further causes the system to automatically prompt for correct verbal input to comply with a predefined format.

20. The method of claim 11 wherein execution of the code further causes the system to provide one or more suggestions for the second audio input.

21. The method of claim 1 wherein the electronic form is a form specifically compiled to meet specific procedural requirements established by a user of the method.

22. The method of claim 1 wherein the claim is prepared as a printed document.

23. The method of claim 1 wherein the claim for reimbursement is prepared in an electronically transmittable format.

24. A system for receiving and processing verbal input from a user of the system describing a medical procedure, analysis, examination, diagnosis, treatment record or similar activity and preparing an electronically transmittable record of that activity comprising
a) an input device in communication with a computer based data storage system and computer based knowledge library, said input device having user specific voice recognition capability
b) a set of preestablished procedural descriptions stored in said knowledge library, said procedural descriptions including blank fields for completion by the user
c) one or more industry standard reimbursement codes electronically stored in said knowledge library
d) a computer based logic program interactive with the preestablished procedural descriptions and said reimbursement codes for alerting the user to blank field input unacceptable to the system
such that a user, upon accessing the system, is provided with
a) means for accessing interactive data stored in the system for a specific patient
b) a user specific standard description of a selected medical, procedure, analysis, diagnosis, treatment record or similar activity, said procedure including blank fields for completion by the user,
c) prompting to assist the user in completing the blank fields and identifying unacceptable verbal inputs provided to complete such blank fields
and, upon completion by the user of the interactive user specific standard description for a selected patient, means for generating a permanent electronically stored record for said specific patient, means for producing a written transcription of said stored record, and means for providing the stored record to medical claims reimbursement generation personnel or software.
